(19) United States
(12) Patent Application Publication
(10) Pub. No.: US 2011/0106849 A1
(43) Pub. Date: May 5, 2011

(54) NEW CASE GENERATION DEVICE, NEW CASE GENERATION METHOD, AND NEW CASE GENERATION PROGRAM

(75) Inventors: Takao Kawai, Minato-ku (JP); Shinichi Ando, Minato-ku (JP)

(73) Assignee: NEC Corporation, Minato-ku, Tokyo (JP)

(21) Appl. No.: 12/922,396

(22) PCT Filed: Mar. 9, 2009
(86) PCT No.: PCT/JP2009/001046

§ 371 Date: Dec. 10, 2010

(30) Foreign Application Priority Data
Mar. 12, 2008 (JP) 2008-062610

(51) Int. Cl. G06F 17/30

(52) U.S. Cl. 707/776; 707/E17.014

(57) ABSTRACT

A new case whose type is the same as that of a case about information desired to be extracted can be generated with high accuracy.

A new case generation device according to the present invention includes: new case generating means that receives a case about information desired to be extracted and a case context being text data that includes data on the case and parts present near the case, and generates, on the basis of the received case and the received case context, new cases and new case contexts with the use of document data, the type of the new cases being the same as that of the received case, and the new case contexts being text data that includes data on the new cases and parts present near the new cases and being different from the case context; similarity calculating means that calculates similarities between the case context and the new case contexts; and new case narrowing down means that narrows down, on the basis of the similarities calculated by the similarity calculating means, the new cases generated by the new case generating means and outputs a new case selected by the narrowing-down operation.

### TECHNICAL FIELD

The present invention relates to a new case generation device, a new case generation method, and a new case generation program. The invention relates more particularly to a new case generation device, a new case generation method and a new case generation program which allow a new case whose type is the same as that of an input case to be generated on the basis of the input case.

### BACKGROUND ART

There is an information extraction device which generates, in response to input of case about information desired to be extracted, an information extraction rule to be used for extracting a case associated with such information, applies the generated information extraction rule to a document to be extracted, and extracts, as an extracted result, information whose type is the same as that of the input case. Generally, when this type of information extraction device can receive a lot of appropriate cases, the quality of an information extraction rule can be improved and the information extraction device can extract information with higher accuracy. For such purpose, a bootstrapping method has been proposed in which a result extracted by the information extraction device is repeatedly used as a new case so that the quality of an information extraction rule is improved.

However, when this type of bootstrapping method is used and the result extracted by the information extraction device includes an error, the information extraction rule is generated on the basis of the erroneous extracted result and the accuracy of the information extraction rule is thereby reduced.

In order to solve the aforementioned problem, various techniques have been proposed. One of the techniques has been provided for calculating, for each of extracted results, a score such as a certainty factor that indicates the degree of certainty with which the extracted result is information desired to be extracted, removing extracted results for which scores have been calculated and are low, and preventing a reduction in the accuracy in an information extraction rule. An example of an information extraction device that is related to the technique for preventing a reduction in the accuracy of an information extraction rule is described in Patent Document 1. In order to increase the accuracy in extracted results, the information extraction device described in Patent Document 1 calculates, for each of the extracted results, a score that indicates the degree of certainty of information desired to be extracted on the basis of an evaluation scale related to the accuracy of the information extraction rule. In addition, the information extraction device described in Patent Document 1 removes extracted results for which scores have been calculated and are low, and thereby prevents a reduction in the accuracy in the extracted results.

As a technique for performing scoring that is related to extraction of cases, Patent Document 2 describes, for example, a case-based inference method for performing scoring on the basis of the degrees of matching between cases searched by search processing and an input phrase and sorting the cases in order from a case for which a score has been calculated and is the highest.
Patent Document 1: JP-A-2005-322120
Patent Document 2: JP-A-2000-137615

### DISCLOSURE OF THE INVENTION

### Problems to be Solved by the Invention

However, when the purpose is to generate an information extraction rule with wide coverage, results extracted by the information extraction device are not sufficient as new cases. In other words, the results extracted by the information extraction device are only information extracted according to the information extraction rule generated on the basis of a case provided in advance. Thus, even when the extracted results are used as new cases, information that can be extracted is lopsided. Therefore, there is a limit in increasing the coverage of the information extraction rule.

In addition, information that is not extracted according to the information extraction rule can be used as a new case for the purpose of improving the coverage of the information extraction rule. In the techniques described in Patent Documents 1 and 2, however, a score that indicates the degree of certainty of information cannot be calculated for this type of the new case. As a result, the new case may include an error.

An object of the present invention is to provide a new case generation device, a new case generation method and a new case generation program which allow a new case whose type is the same as that of a case about information desired to be extracted to be generated in response to input of the case.

### Means for Solving the Problems

A new case generation device according to the present invention includes: new case generating means that receives a case about information desired to be extracted and a case context being text data that includes data on the case and parts present near the case, and generates, on the basis of the received case and the received case context, new cases and new case contexts with the use of document data, wherein the type of the new cases is the same as that of the received case, and the new case contexts are text data including data on the new cases and parts present near the new cases and are different from the received case context; similarity calculating means that calculates similarities between the case context and the new case contexts; and new case narrowing down means that narrows down, on the basis of the similarities calculated by the similarity calculating means, the new cases generated by the new case generating means and outputs a new case selected by the narrowing-down operation.

A new case generation method according to the present invention includes the steps of: receiving a case about information desired to be extracted and a case context being text data that includes data on the case and parts present near the case, and generating, on the basis of the received case and the received case context, new cases and new case contexts with the use of document data, wherein the type of the new cases is the same as that of the received case, and the new case contexts are text data including data on the new cases and parts present near the new cases and are different from the received case context; calculating similarities between the case context and the new case contexts; and narrowing down the generated new cases on the basis of the calculated similarities and outputting a new case selected by the narrowing-down operation.

A new case generation program according to the present invention, which causes a computer to execute: new case generation processing of receiving a case about information desired to be extracted and a case context being text data that includes data on the case and parts present near the case, and generating, on the basis of the received case and the received case context, new cases and new case contexts with the use of document data, wherein the type of the new cases is the same as that of the received case, and the new case contexts are text data including data on the new cases and parts present near the new cases and are different from the received case context; similarity calculation processing of calculating similarities between the case context and the new case contexts; and new case narrowing down processing of narrowing down the generated new cases on the basis of the calculated similarities and outputting a new case selected by the narrowing-down operation.

### EFFECT OF THE INVENTION

According to the present invention, new cases whose type is the same as that of a case about information desired to be extracted can be generated with high accuracy.

### BRIEF DESCRIPTION OF THE DRAWINGS

FIG. 1 is a block diagram showing an example of the configuration of a new case generation device according to the present invention.

FIG. 2 is a flowchart of an example of a process of generating new cases whose type is the same as that of a case received by the new case generation device.

FIG. 3 is a block diagram showing an example of the configuration of a new case generation device according to a second embodiment of the present invention.

FIG. 4 is a flowchart of an example of a process of generating new cases whose type is the same as that of a case received by the new case generation device according to the second embodiment.

FIG. 5 is a block diagram showing an example of the configuration of a new case generation device according to a third embodiment of the present invention.

FIG. 6 is a flowchart of an example of a process of generating new cases whose type is the same as that of a case received by the new case generation device according to the third embodiment.

FIG. 7 is a diagram showing an example of document data.

FIG. 8 is a diagram showing an example of a case and an example of a case context.

FIG. 9 is a diagram showing examples of new cases and examples of new case contexts.

FIG. 10 is a diagram showing an example of output results obtained by narrowing down new cases.

FIG. 11 is a diagram showing an example of the minimum configuration of the new case generation device.

### DESCRIPTION OF THE REFERENCE NUMERALS

11, 11A . . . Data receiving section
12 . . . New case generating section
13 . . . Similarity calculating section
14, 14A . . . New case narrowing down section
15 . . . Extraction rule applying section
16 . . . Extraction rule generating section

### BEST MODE FOR CARRYING OUT THE INVENTION

### First Embodiment

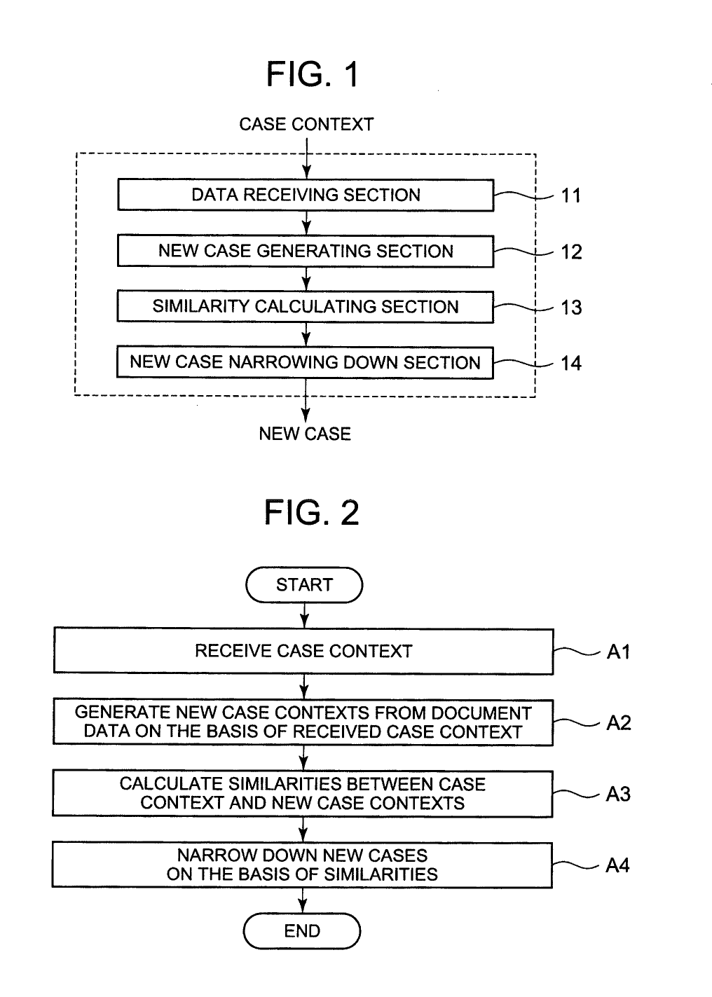

A first embodiment of the present invention is described below with reference to the accompanying drawings. FIG. 1 is a block diagram showing an example of the configuration of a new case generation device according to the present invention. As shown in FIG. 1, the new case generation device includes a data receiving section 11, a new case generating section 12, a similarity calculating section 13, and a new case narrowing down section 14.

In the present embodiment, the data receiving section 11 receives a case about information desired to be extracted and a case context being text data that includes data on the case and parts present near the case. The new case generating section 12 extracts, as new cases, information that is candidates for a new case from document data in accordance with requirements obtained on the basis of the received case. The new case generating section 12 generates new case contexts that are text data including data on the new cases and parts present near the new cases and are different from the received case context. The similarity calculating section 13 calculates similarities between the case context and the new case contexts. The new case narrowing down section 14 narrows down the new cases on the basis of the similarities calculated by the similarity calculating section 13 and outputs a new case selected by the narrowing-down operation. Alternatively, the similarity calculating section 13 calculates the similarities between the case context and the new case contexts and calculates the degrees (pattern difference degrees) of differences between data that is a part of the case context and data that is parts of the new case contexts, and the new case narrowing down section 14 narrows down the new cases on the basis of the similarities and the pattern difference degrees calculated by the similarity calculating section 13 and outputs a new case selected by the narrowing-down operation.

In the present embodiment, the new case generation device is achieved specifically by an information processing device such as a personal computer that operates according to programs.

The processing sections shown in FIG. 1 each operate basically as follows.

The data receiving section 11 is achieved specifically by a CPU of the information processing device that operates according to the programs. The data receiving section 11 has a function of receiving a case context that is text data including data on a case about information desired to be extracted and parts present near the case.

For example, the data receiving section 11 receives a case desired to be extracted (e.g., the name of a famous politician or the name of a famous incident) from an input device such as a keyboard, a mouse or the like according to a user operation. Then, the data receiving section 11 extracts, from the document data stored in a document database, a case context that includes the received case, and receives the extracted case context.

The new case generating section 12 is achieved specifically by the CPU of the information processing device that operates according to the programs. The new case generating section 12 has a function of extracting, as new cases, information that is candidates for a new case from the document data in accordance with requirements obtained on the basis of the case received by the data receiving section 11. In addition, the new case generating section 12 has a function of generating new case contexts that are different from the case context and are text data including data on the extracted new cases and parts present near the extracted new cases.

For example, the new case generating section 12 generates, using the document data, new cases that each have the same character string as a character string corresponding to the case and are included in new case contexts that are text data and different from the case context that includes the case. In addition, the new case generating section 12 may generate, using the document data, new cases that each have the same pattern of a morpheme string as a predetermined pattern of a morpheme string corresponding to the case and are included in new case contexts that are text data different from the case context including the morpheme string. In addition, the new case generating section 12 may generate, as the new case contexts, text data that includes at least one group of a predetermined number of character strings, a predetermined number of morphemes, a predetermined number of sentences, and a predetermined number of paragraphs, all of which are present near the new cases.

The similarity calculating section 13 is achieved specifically by the CPU of the information processing device that operates according to the programs. The similarity calculating section 13 has a function of calculating similarities between a topic of the case context received by the data receiving section 11 and topics of the new case contexts generated by the new case generating section 12. Alternatively, the similarity calculating section 13 may have a function of calculating the similarities and the degrees (pattern difference degrees) of differences between data that is a part of the case context and data that is parts of the new case contexts.

The new case narrowing down section 14 is achieved specifically by the CPU of the information processing device that operates according to the programs. The new case narrowing down section 14 has a function of narrowing down, on the basis of the similarities calculated by the similarity calculating section 13, the new cases generated by the new case generating section 12. Alternatively, the new case narrowing down section 14 has a function of narrowing down, on the basis of the similarities and the pattern difference degrees calculated by the similarity calculating section 13, the new cases generated by the new case generating section 12. In addition, the new case narrowing down section 14 has a function of outputting a new case selected by the narrowing-down operation. In this case, for example, the new case narrowing down section 14 causes a display device or the like to display, on a display unit, the new case selected by the narrowing-down operation.

In the present embodiment, a storage device (not shown) of the new case generation device stores various programs that are used to generate new cases whose type is the same as that of the received case. For example, the storage device of the new case generation device stores a new case generation program. The new case generation program causes the computer to execute new case generation processing so that the computer receives a case and a case context being text data that includes data on the case and parts present near the case, and generates, on the basis of the received case and the received case context, new cases and new case contexts with the use of the document data. In this case, the new cases are of the same type as the received case, while the new case contexts are text data including data on the new cases and parts present near the new cases and are different from the received case context. Furthermore, the new case generation program causes the computer to execute similarity calculation processing so that the computer calculates similarities between the received case context and the new case contexts and calculates the degrees (pattern difference degrees) of differences between data that is a part of the received case context and data that is parts of the new case contexts. Furthermore, the new case generation program causes the computer to execute new case narrowing down processing so that the computer narrows down the generated new cases on the basis of the calculated similarities and the calculated pattern difference degrees and outputs a new case selected by the narrowing-down operation.

Next, operations of the new case generation device are described. FIG. 2 is a flowchart of an example of a process of generating new cases whose type is the same as that of the case received by the new case generation device. First, the data receiving section 11 receives a case context being text data that includes data on the case about information desired to be extracted and parts present near the case (in step A1 shown in FIG. 2). For example, when a user enters a case, the data receiving section 11 receives the case to be extracted and starts the new case generation processing that includes step A1 and the subsequent step.

Next, the new case generating section 12 sets requirements for extracting the case context in accordance with the case received by the data receiving section 11. The new case generating section 12 extracts, as new cases, information that is candidates for a new case from the document data on the basis of the set requirements (stored in the document database in advance, for example). The new case generating section 12 compares the case context with text data present near each of the extracted new cases. When the case context is different from the text data present near the extracted new case, the new case generating section 12 uses the new case and generates a new case context from the text data present near the new case (in step A2). The generated new cases each include, as the new case contexts, the contexts that are different from the received case context. Thus, when the new cases and the new case contexts are used in order to generate a new information extraction rule, the new information extraction rule that cannot be generated from the received case can be generated. In addition, when the text data present near the new case is the same as the case context and the generated new case is used as the new case, the coverage of the information extraction rule cannot be increased. Thus, in this case, the generated new case is not used as the new case and discarded.

Next, the similarity calculating section 13 calculates similarities between the case context received by the data receiving section 11 and the new case contexts generated by the new case generating section 12 (in step A3). Alternatively, the similarity calculating section 13 calculates the similarities and the degrees (pattern difference degrees) of differences between data that is a part of the case context and data that is parts of the new case contexts.

Next, the new case narrowing down section 14 narrows down the new cases on the basis of the similarities calculated by the similarity calculating section 13. Alternatively, the new case narrowing down section 14 narrows down the new cases on the basis of the similarities and the pattern difference degrees calculated by the similarity calculating section 13. Then, the new case narrowing down section 14 outputs a new case selected by the narrowing-down operation (in step A4). For example, the new case narrowing down section 14 causes the display device to display the new case selected by the narrowing-down operation and the new case context.

In step A4, as a narrowing down method, the new case narrowing down section 14 may sort the new case contexts in order from a new case context for which a similarity has been calculated and is highest to a new case context for which a similarity has been calculated and is lowest. In step A4, the new case narrowing down section 14 may extract, as results obtained by the narrowing-down operation, a predetermined number of new case contexts for which similarities have been calculated and sorted in the top predetermined number of ranks. In addition, the new case narrowing down section 14 may extract, as the results obtained by the narrowing-down operation, new cases that are included in new case contexts for which similarities have been calculated and are higher than a predetermined value. Alternatively, as another narrowing down method, the new case narrowing down section 14 may sort new case contexts in order from a new case context for which a similarity has been calculated and is high and a pattern difference degree has been calculated and is highest to a new case context for which a similarity has been calculated and is high and a pattern difference degree has been calculated and is lowest. Then, the new case narrowing down section 14 may extract, as the results obtained by the narrowing-down operation, a predetermined number of new case contexts for which pattern difference degrees have been calculated and sorted in the top predetermined number of ranks.

As described above, according to the present embodiment, the new case generation device generates, on the basis of the case about information desired to be extracted, new cases that are candidates for a new case. In addition, the new case generation device generates new case contexts that are different from the received case context. In addition, the new case generation device calculates the similarities between the received case context and the generated new case contexts. Alternatively, the new case generation device calculates the similarities and the degrees (pattern difference degrees) of differences between data that is a part of the case context and data that is parts of the new case contexts. In this manner, the new cases are narrowed down on the basis of the similarities or on the basis of the similarities and the pattern difference degrees. Thus, it is possible to generate, with high accuracy, new cases whose type is the same as that of the information desired to be extracted and which include new contexts different from the received case context. In addition, it is possible to output, with high accuracy, a new case that allows the coverage of the information extraction rule to be increased. Therefore, it is possible to generate, with high accuracy, a new case that allows the coverage of the information extraction rule to be increased on the basis of a case desired to be extracted.

In the present embodiment, the similarities between the received case context and the new case contexts, which indicate whether or not the received case context and the new case contexts are similar to each other, are calculated. When the received case context and the new case context are similar to each other, the similarity for which the new case context that includes the new case has been calculated is high. The new cases are narrowed down to a new case that is included in a new case context for which a similarity has been calculated and is high. In this manner, it is possible to generate, with high accuracy, a new case whose type is the same as that of the received case and which includes a new context that is different from the received context. Alternatively, in the present embodiment, the similarities between the received case context and the new case contexts are calculated, and the degrees (pattern difference degrees) of the differences between the data that is the part of the received case context and the data that is the parts of the new case contexts are calculated. Thus, whether or not the received case context and each of the new case contexts are similar to each other is calculated, and whether or not a tendency of appearance of each of the new cases is different from a tendency of appearance of the case is calculated. When the received case context and the new case context are similar and the tendencies are different, the similarity calculated for the new case context that includes the new case is high, and the pattern difference degree calculated for the new case context that includes the new case is high. The new cases are narrowed down to the new case that is included in the new case context for which the similarity and pattern difference degree have been calculated and are high. In this manner, it is possible to generate, with high accuracy, new cases whose type is the same as that of the received case and which include new contexts different from the received case context.

For example, it is assumed that a case “Visit of US President Bush to Japan” is received as the received case. In this case, the new case generation device generates, as candidates for a new case, cases such as “Mrs. Bush”, “Bûche de Noël” and the like. Then, the new case generation device calculates a similarity between a case context including the case “Visit of US President Bush to Japan” and a new case context including the case “Mrs. Bush”. Also, the new case generation device calculates a similarity between the case context including the case “Visit of US President Bush to Japan” and a new case context including the case “Bûche de Noël”. Then, the new case generation device narrows down the new cases to the case “Mrs. Bush” included in the new case context for which the similarity has been calculated and is high. The new case generation device extracts and outputs the new case “Mrs. Bush”.

As described above, in the present embodiment, cases are not simply compared with each other. In the present embodiment, the case context that includes data on the case and parts present in front and back of the case is compared with the new case contexts that each include data on a new case and parts present in front and back of the new case so that the new cases are narrowed down. In this manner, a new case is extracted. Thus, in the present embodiment, the new cases that are related to the received case can be generated and output with high accuracy. In the aforementioned example, it can be considered that a case context that includes data on the case “Visit of US President Bush to Japan” and parts present in front and back of the case “Visit of US President Bush to Japan” includes a lot of words that are related to politics. Also, in the aforementioned example, it can be considered that the case context that includes data on the case “Mrs. Bush” and parts present in front and back of the case “Mrs. Bush” includes a lot of words that are related to politics. On the other hand, it can be considered that the case context that includes data on the case “Bûche de Noël” and parts present in front and back of the case “Bûche de Noël” includes a lot of words that are related to cakes or Christmas and does not include a word relating to politics. Thus, the case “Bûche de Noël” that has little association with politics can be removed from the new cases by comparing a similarity between the contexts. Therefore, the new case that is related to the received case can be generated and output with high accuracy.

### Second Embodiment

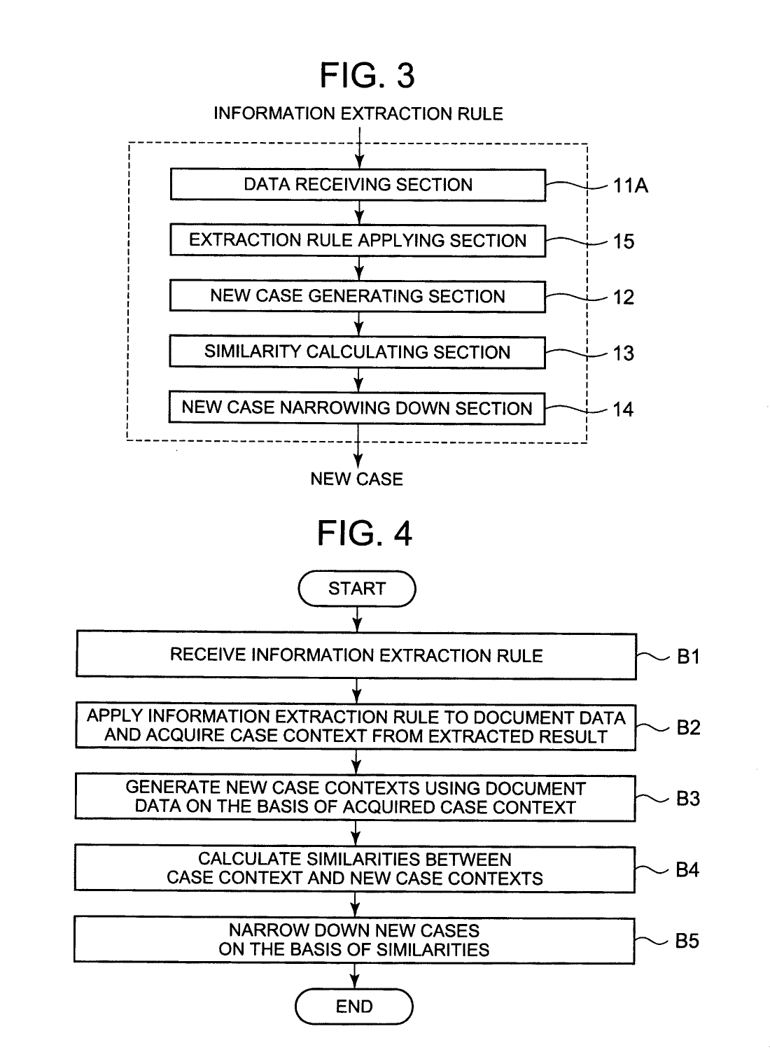

Next, a second embodiment of the present invention is described with reference to the accompanying drawings. FIG. 3 is a block diagram showing an example of the configuration of a new case generation device according to the second embodiment. As shown in FIG. 3, the new case generation device includes a data receiving section 11A, an extraction rule applying section 15, a new case generating section 12, a similarity calculating section 13, and a new case narrowing down section 14.

As shown in FIG. 3, the new case generation device according to the second embodiment is different from the new case generation device according to the first embodiment in that the new case generation device according to the second embodiment has the extraction rule applying section 15 in addition to the constituent elements shown in FIG. 1. In addition, in the present embodiment, the data receiving section 11A has a function that is different from the function of the data receiving section 11 described in the first embodiment.

The data receiving section 11A receives an information extraction rule. The extraction rule applying section 15 acquires, from results extracted by applying the information extraction rule to the document data, a case and a case context being text data that includes data on the case and parts present near the case. The new case generating section 12 extracts, as new cases, information that is candidates for a new case from the document data according to requirements obtained on the basis of the acquired case. Then, the new case generating section 12 generates new case contexts that are text data present near the new case and are different from the acquired case context. The similarity calculating section 13 calculates similarities between the case context and the new case contexts. The new case narrowing down section 14 narrows down the new cases on the basis of the similarities calculated by the similarity calculating section 13 and outputs a new case selected by the narrowing down operation. Alternatively, the similarity calculating section 13 calculates the similarities between the case context and the new case contexts and calculates the degrees (pattern difference degrees) of differences between data that is a part of the case context and data that is parts of the new case contexts. The new case narrowing down section 14 narrows down the new cases on the basis of the similarities and the pattern difference degrees calculated by the similarity calculating section 13 and outputs a new case selected by the narrowing-down operation.

The processing sections shown in FIG. 3 operate basically as follows.

The data receiving section 11A is achieved specifically by a CPU of the information processing device that operates according to programs. The data receiving section 11A has a function of receiving an information extraction rule that is used to extract a case to be extracted.

The extraction rule applying section 15 is achieved specifically by the CPU of the information processing device that operates according to the programs. The extraction rule applying section 15 has a function of applying the information extraction rule received by the data receiving section 11 to the document data and extracting a case. In addition, the extraction rule applying section 15 has a function of acquiring, on the basis of the extracted result (case), a case context that is text data including data on the case and parts present near the case.

For example, the extraction rule applying section 15 extracts, from the document data stored in the document database, a case that matches the information extraction rule. Then, the extraction rule applying section 15 extracts, from the document data stored in the document database, a case context that includes the extracted case.

The new case generating section 12 is achieved specifically by the CPU of the information processing device that operates according to the programs. The new case generating section 12 has a function of extracting, as new cases, information that is candidates for a new case from the document data in accordance with the requirements obtained on the basis of the case generated by the extraction rule applying section 15. In addition, the new case generating section 12 has a function of generating new case contexts that are different from the case context and are text data including data on the extracted new cases and parts present near the new cases.

The similarity calculating section 13 is achieved specifically by the CPU of the information processing device that operates according to the programs. The similarity calculating section 13 has a function of calculating similarities between a topic of the case context extracted by the extraction rule applying section 15 and topics of the new case contexts generated by the new case generating section 12. Alternatively, the similarity calculating section 13 has the function of calculating the aforementioned similarities and a function of calculating the degrees (pattern difference degrees) of differences between data that is a part of the case context and data that is parts of the new case contexts.

The new case narrowing down section 14 is achieved specifically by the CPU of the information processing device that operates according to the programs. The new case narrowing down section 14 has a function of narrowing down, on the basis of the similarities calculated by the similarity calculating section 13, the new cases generated by the new case generating section 12. Alternatively, the new case narrowing down section 14 has a function of narrowing down, on the basis of the similarities and the pattern difference degrees calculated by the similarity calculating section 13, the new cases generated by the new case generating section 12. In addition, the new case narrowing down section 14 has a function of outputting a new case selected by the narrowing-down operation. In this case, for example, the new case narrowing down section 14 causes a display device or the like to display, on a display unit, the new case selected by the narrowing-down operation.

Next, operations of the new case generation device are described. FIG. 4 is a flowchart of an example of a process of generating new cases whose type is the same as that of a result extracted on the basis of the information extraction rule received by the new case generation device according to the second embodiment. First, the data receiving section 11A receives an information extraction rule that is used to extract information desired to be extracted (in step B1 shown in FIG. 4). For example, when the user enters an information extraction rule, the data receiving section 11A receives the information extraction rule (in step B1) and the process (including step B1 and subsequent steps) of generating new cases starts.

Next, the extraction rule applying section 15 applies the information extraction rule received by the data receiving section 11A to the document data and extracts a case to be extracted. In addition, the extraction rule applying section 15 treats the extracted result as a case and extracts a case context that is text data including data on the case and parts present near the case (in step B2).

Next, the new case generating section 12 sets requirements for extracting a case context on the basis of the case that is the result extracted by the extraction rule applying section 15. In addition, the new case generating section 12 extracts, as new cases, information that is candidates for a new case from the document data (e.g., document data stored in the document database) in accordance with the set requirements. Then, the new case generating section 12 compares the case context with text data present near each of the extracted new cases. When the text data present near the extracted new case is different from the case context, the new case generating section 12 uses the new case and treats the text data present near the new case as a new case context (in step B3).

Next, the similarity calculating section 13 calculates similarities between the case context extracted by the extraction rule applying section 15 and the new case contexts generated by the new case generating section 12 (in step B4). Alternatively, the similarity calculating section 13 calculates the similarities and the degrees (pattern difference degrees) of differences between data that is a part of the case context and data that is parts of the new case contexts.

The extraction rule applying section 15 may cause a case storage section (e.g., buffer formed in a RAM) to store the extracted case context. In addition, the new case generating section 12 may cause a new case storage section (e.g., buffer formed in the RAM) to store the generated new case contexts. In step B4, the similarity calculating section 13 may reference the case context stored in the case storage section, the new case contexts stored in the new case context storage section, and the document data stored in advance in a document storage section (e.g., buffer formed in the RAM), and calculate the similarities and the pattern difference degrees.

Next, the new case narrowing down section 14 narrows down the new cases on the basis of the similarities calculated by the similarity calculating section 13. Alternatively, the new case narrowing down section 14 narrows down the new cases on the basis of the similarities and the pattern difference degrees calculated by the similarity calculating section 13. The new case narrowing down section 14 outputs, as an extracted result, a new case selected by the narrowing-down operation (in step B5). For example, the new case narrowing down section 14 causes the display device to display the new case selected by the narrowing-down operation.

As described above, according to the present embodiment, the new case generation device applies the information extraction rule to the document data and extracts the case context from the extracted information. In addition, the new case generation device generates, on the basis of the case, the new case contexts that are different from the case context. Furthermore, the new case generation device calculates the similarities between the topic of the case context and the topics of the new case contexts and the degrees (pattern difference degrees) of the differences between the data that is the part of the case context and the data that is the parts of the new case contexts. Then, the new case generation device narrows down the new cases to a new case that includes a new context for which a similarity has been calculated and is high. Alternatively, the new case generation device narrows down the new cases to a new case that includes a new context for which a similarity and a pattern difference degree have been calculated and are high. Since the new case generation device has the aforementioned configuration, the new case generation device is capable of generating new cases whose type is the same as that of information extracted according to the received information extraction rule and which include new contexts different from the case context with high accuracy. In addition, according to the present embodiment, it is possible to acquire, as new cases, information that cannot be extracted according to a received information extraction rule but is intended to be extracted according to the received information extraction rule.

### Third Embodiment

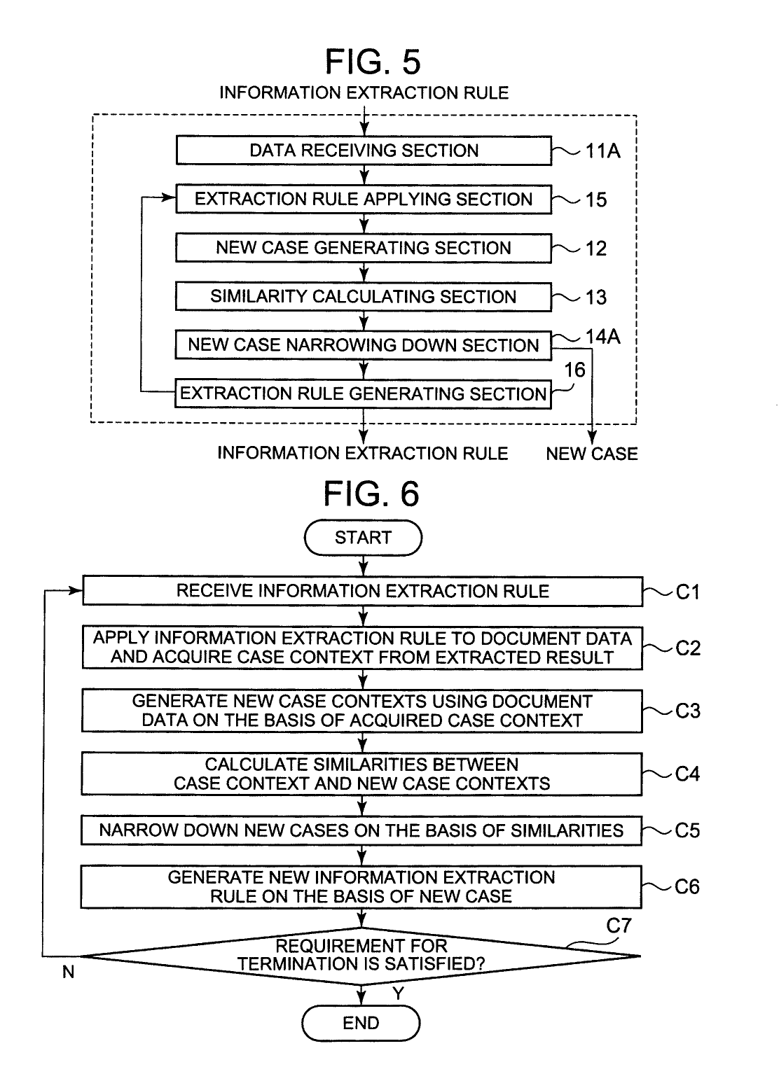

Next, a third embodiment of the present invention is described with reference to the accompanying drawings. FIG. 5 is a block diagram showing an example of the configuration of a new case generation device according to the third embodiment. As shown in FIG. 5, the new case generation device according to the third embodiment is different from the new case generation device according to the second embodiment in that the new case generation device according to the third embodiment has an extraction rule generating section 16 in addition to the constituent elements shown in FIG. 3. In addition, a new case narrowing down section 14A has a function that is different from the function of the new case narrowing down section 14 described in the second embodiment.

The new case narrowing down section 14A is achieved specifically by a CPU of the information processing device that operates according to programs. The new case narrowing down section 14A has a function of narrowing down, on the basis of the similarities calculated by the similarity calculating section 13 or on the basis of the similarities and the pattern difference degrees calculated by the similarity calculating section 13, the new cases generated by the new case generating section 12. In addition, the new case narrowing down section 14A has a function of outputting a new case selected by the narrowing-down operation. In this case, for example, the new case narrowing down section 14A causes a display device or the like to display, on a display unit, the new case selected by the narrowing-down operation.

In addition, the new case narrowing down section 14A has a function of transmitting (outputting), to the extraction rule generating section 16, the result selected by the narrowing-down operation of the new cases.

The extraction rule generating section 16 is achieved specifically by the CPU of the information processing device that operates according to the programs. The extraction rule generating section 16 has a function of generating an information extraction rule that is used to extract the new case selected by the narrowing-down operation that has been performed by the new case narrowing down section 14A. In addition, the extraction rule generating section 16 has a function of outputting the generated information extraction rule. In this case, for example, the extraction rule generating section 16 causes the display device or the like to display, on the display unit, the generated information extraction rule. In addition, the extraction rule generating section 16 may transmit (output) the generated information extraction rule to the data receiving section 11 so that the information extraction rule is used as the next received information extraction rule.

Functions of the data receiving section 11A, the extraction rule applying section 15, the new case generating section 12, and the similarity calculating section 13 are the same as the functions of the sections 11A, 15, 12, and 13 described in the second embodiment.

Next, operations of the new case generation device are described. FIG. 6 is a flowchart of an example of a process of generating new cases whose type is the same as that of a case received by the new case generation device according to the third embodiment. Operations of the data receiving section 11A, the extraction rule applying section 15, the new case generating section 12, and the similarity calculating section 13, which are performed in steps C1 to C4 shown in FIG. 6, are the same as the operations of the data receiving section 11A, the extraction rule applying section 15, the new case generating section 12, and the similarity calculating section 13, which are performed in steps B1 to B4 shown in FIG. 4. Thus, a description of steps C1 to C4 is omitted.

The second embodiment describes the case in which the new case narrowing down section 14 outputs a result obtained by the narrowing-down operation of the new cases on the basis of the similarities calculated by the similarity calculating section 13 or on the basis of the similarities and the pattern difference degrees calculated by the similarity calculating section 13 in step B5. In contrast, in the present embodiment, the new case narrowing down section 14A not only outputs a result obtained by the narrowing-down operation of the new cases but also transmits the result to the extraction rule generating section 16 (in step C5 shown in FIG. 6). In this case, in order to increase the accuracy in the generation of an information extraction rule that is performed by the extraction rule generating section 16, the new case narrowing down section 14A may transmit (output) a new case removed by the narrowing-down operation and information such as the similarities used for the narrowing-down operation and the like as well as the new case selected by the narrowing-down operation. For example, the accuracy in the information extraction rule can be increased when the extraction rule generating section uses the new case removed by the narrowing-down operation as a negative case and uses the information such as the similarities and the like so that a new case that includes a new context for which a similarity has been calculated and is high, or a new case that includes a new context for which a similarity and a pattern difference degree have been calculated and are high, is prioritized and extracted.

Next, the extraction rule generating section 16 generates an information extraction rule that is used to extract a result (new case selected by the narrowing-down operation) extracted by the new case narrowing down section 14A. Then, the extraction rule generating section 16 outputs the generated information extraction rule (in step C6). For example, the extraction rule generating section 16 causes the display device to display the generated information extraction rule.

The process may be terminated after the information extraction rule is output in step C6. However, the new case generation device performs the following step with the use of a bootstrapping method in order to increase the quality of the information extraction rule.

The extraction rule generating section 16 determines whether or not a requirement for termination is satisfied (in step C7). When the requirement for the termination is satisfied, the process is terminated. When the requirement for the termination is not satisfied, the extraction rule generating section 16 transmits (outputs) the generated information extraction rule to the data receiving section 11A. The data receiving section 11A uses, as the next received rule, the information extraction rule transmitted from the extraction rule generating section 16.

For example, as a method for determining whether or not a requirement for the termination is satisfied in step C7, the extraction rule generating section 16 may determine whether or not the information extraction rule has been generated. In this case, when the extraction rule generating section 16 determines that the information extraction rule is not generated, the process is terminated. When the extraction rule generating section 16 determines that the information extraction rule has been generated, the process continues. In addition, for example, as another method for determining whether or not a requirement for the termination is satisfied in step C7, the extraction rule generating section 16 may set the number of cycles of steps C1 to C7 in advance. In this case, when the number of cycles of steps C1 to C7 reaches the set number, the process is terminated. In addition, for example, the extraction rule generating section 16 may set the number of information extraction rules to be generated in advance and may calculate the number of generated information extraction rules. In this case, when the number of generated information extraction rules reaches the set number, the process is terminated. The method for determining whether or not a requirement for the termination is satisfied is not limited to the aforementioned methods. The extraction rule generating section 16 may determine, using another method, whether or not a requirement for the termination is satisfied.

As described above, according to the present embodiment, in the new case generation device, the extraction rule generating section 16 generates a new information extraction rule with the use of results extracted by the new case narrowing down section 14A. Since the new case generation device has the aforementioned configuration, it is possible to not only extract new information whose type is the same as that of information extracted according to a first received information extraction rule but also generate a new information extraction rule that is used to extract the information whose type is the same as that of the information extracted according to the first received information extraction rule.

The data receiving section, the extraction rule applying section, the new case generating section, the similarity calculating section, the new case narrowing down section, and the extraction rule generating section (described in the first to third embodiment) may be provided in units, respectively, while the units are separated from each other.

### First Example

Next, a first example of the present invention is described with reference to the accompanying drawings. A new case generation device according to the first example corresponds to the new case generation device according to the first embodiment of the present invention.

In the first example, the new case generation device is achieved by a computer. Specifically, the computer is a data processing device such as a personal computer or a work station. In addition, the computer includes known constituent sections: an input interface section that is connected to an input device such as a keyboard and outputs, to a central processing unit (CPU), an operation signal transmitted from the input device; a read only memory (ROM); a random access memory (RAM); an output interface section that connects the computer to an output device such as a display device or the like; a hard disk (HD); the CPU; and the like.

The ROM stores a program that is used for basic control of each section of the new case generation device. The program may be stored in an external storage device. The RAM is used as a work area of the CPU and temporarily stores various data and a program that is executed by the CPU.

The program stored in the ROM is read by the RAM, and the CPU operates under control of the program read by the RAM. Since the CPU operates under the control of the program read by the RAM, the CPU functions as each of the processing sections such as the data receiving section 11, the new case generating section 12, the similarity calculating section 13, and the new case narrowing down section 14. The CPU generates a document storage section, a case storage section, and a new case storage section in the RAM as the buffers. The document storage section stores the document data. The case storage section stores a case context. The new case storage section stores new case contexts.

The HD stores software such as an operating system which controls the computer. In addition, the document data may be stored in the HD in advance, and the RAM may arbitrarily read necessary document data from the HD when the computer operates.

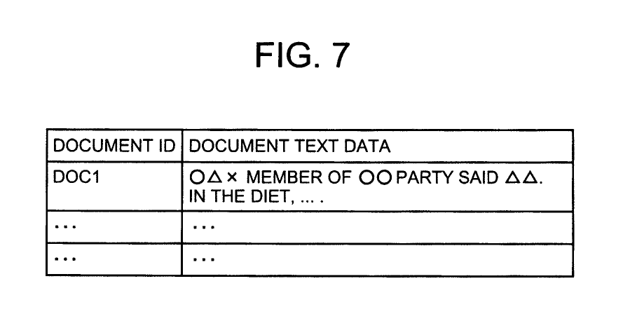

FIG. 7 is a diagram showing an example of the document data. The document data shown in FIG. 7 is read from an external storage device or the like and stored in the document storage section. As shown in FIG. 7, the document storage section stores a document ID and text data that is a document, while the document ID is associated with the text data. The document ID is an identifier that is used to identify the document data. In the first example, as shown in FIG. 7, the document storage section stores a document ID “DOC1” and document text data associated with the document ID “DOC1”. The document text data is constituted by multiple sentences that include document contents “∘Δ× member of ∘∘ party said ΔΔ”.

The document text data may be an electronic file such as an HTML file, an electronic mail, or a word processor document. In this case, the CPU extracts only the text data from the electronic file beforehand and stores the extracted text data or stores the text data and other information in a format that allows the text data and the information to be identified.

In addition, the document storage section may store information pieces that are sentences obtained by dividing the document text data. In addition, the document storage section may store the text data and the results of language analysis processing (such as morpheme analysis or syntax analysis) on the text data, while the text data is associated with the results of the language analysis processing.

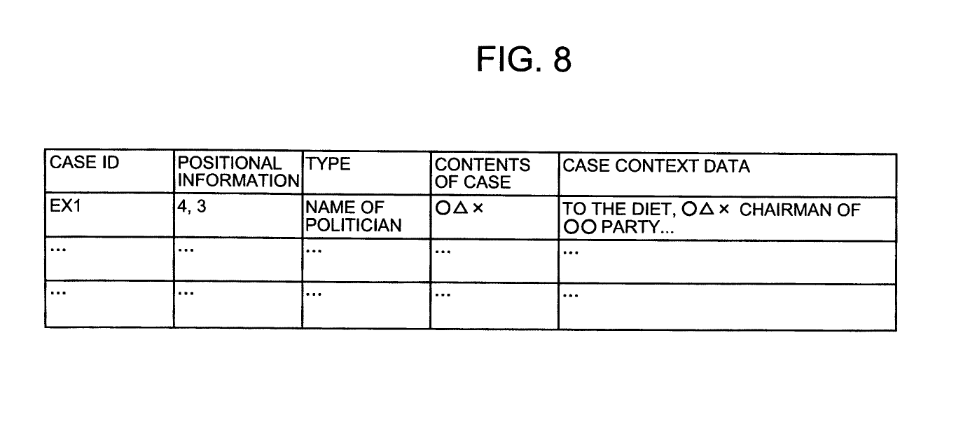

When the program is executed, the CPU functions as the data receiving section 11 and receives information shown in FIG. 8. FIG. 8 shows an example of a case and a case context. The CPU receives the information shown in FIG. 8 and stores the information in the case storage section.

As shown in FIG. 8, the CPU causes the case storage section to store a case ID, the case context data, positional information, a type of the case, while the case ID, the case context data, the positional information, and the type of the case are associated with each other in the case storage section. The case ID is an identifier that identifies the case. The case context data includes the case. The positional information indicates the position of the case in the case context data. As shown in FIG. 8, the CPU may cause the case storage section to store the content of the case that is a part of text data corresponding to the case, while the content of the case is associated with the case ID, the case context data, the positional information and the type of case.

The positional information indicates the position of information desired to be extracted as the case. The positional information may be in a format that allows the positional information to be represented by offset information included in the case context data. For example, when the length of the information desired to be extracted has been determined, the positional information is represented only by the offset information included in the case context data. In addition, the positional information may be in a format that allows the positional information to be represented by offset information located at the beginning of the case context data and offset information located at the end of the case context data. In addition, for example, the positional information may be in a format that allows the positional information to be represented by length information and offset information located at the beginning of information desired to be extracted that is included in the case context data. Instead of the positional information, a tag that indicates the case may be added to the case context data and stored so that the position of the case can be identified. The format of the positional information stored in the case storage section is not limited to the formats described in the present example.

In the present example, as shown in FIG. 8, the CPU causes the case storage section to store the case and the case context, while the case is associated with the case context, for example. In the example shown in FIG. 8, it is apparent that a content of the case is located next to the fourth character of the case context data corresponding to a case ID “EX1” and has a length of three characters on the basis of the positional information “4, 3”. The length information of the positional information may not be necessary when the length information is apparent from the content of the case.

In the example shown in FIG. 8, it is apparent that the case of the case ID “EX1” has a character string “∘Δ×” and the type of the case is specified as “Name of politician”. The present example describes the case in which the case context data shown in FIG. 8 is directly stored in the case storage section. The case storage section may store the document data stored in the document storage section and information that specifies text data that is a part of a paragraph or the like of the document data instead of the case context data.

Subsequently, the CPU functions as the new case generating section 12 and sets requirements obtained on the basis of the case shown in FIG. 8. The CPU extracts, as new cases, information that is candidates for the new case data from the plurality of documents (shown in FIG. 7) stored in the document storage section on the basis of the set requirements. Then, the CPU generates new case contexts with the use of text data that includes data on the extracted new cases and parts present near the new cases. Then, the CPU causes the new case storage section to store the generated new case contexts.

The CPU generates new case contexts with the use of text data that is different from the case context. For example, the CPU can determine a new case context on the basis of the fact that a character string and a morpheme that are present near a new case are different from those present near the case and of the fact that a sentence that includes the new case is different from a sentence that includes the case.

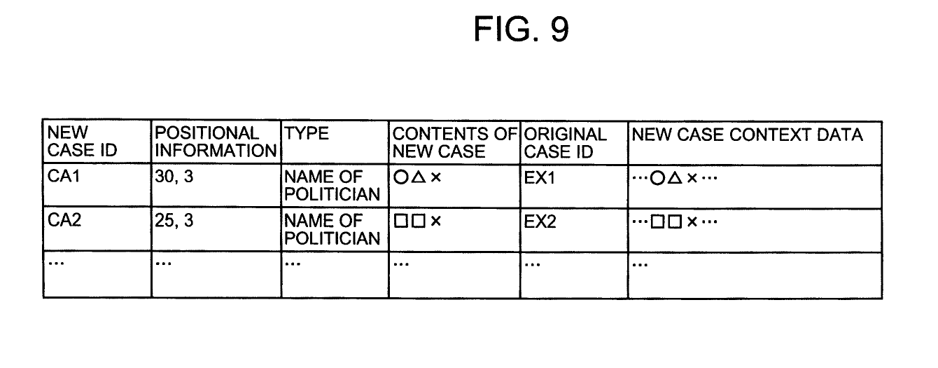

FIG. 9 is a diagram showing an example of the new cases and the new case contexts. As shown in FIG. 9, the CPU causes the new case storage section to store new case IDs, new case context data, positional information, and a type of new cases, while the new case ID, the new case context data, the positional information, and the type of the new cases are associated with each other in the new case storage section. The new case IDs are identifiers that identify the new cases, respectively. The new case context data includes the new cases. The positional information indicates the positions of the new cases in the new case context data. As shown in FIG. 9, the CPU may cause the new case storage section to store the contents of the new cases that is a part of text data corresponding to the new cases while the contents of the new cases are associated with the new case IDs, the new case context data, the positional information, and the type of the new cases in the new case storage section. The type of the new cases is the same as the type of the case.

For example, the CPU may use, as the requirements obtained on the basis of the case, information that includes the same character string as the content of the case. Specifically, when new cases are to be generated on the basis of the case corresponding to the case ID “EX1” shown in FIG. 8, the CPU extracts data that includes the character string “∘Δ×” that is the content of the case corresponding to the case ID. Then, the CPU uses the extracted data as the new cases. The CPU uses, as the new case contexts, text data including data on the new cases and parts present near the new cases. The CPU may use, as the new case contexts, entire documents that include the new cases.

The CPU may use, as the requirements obtained on the basis of the case, information about a morpheme string corresponding to the content of the case. For example, the CPU extracts, from results of morpheme analysis on the case context data, a morpheme string that corresponds to the content of the case. Then, the CPU extracts, as the new cases from the document data, data that includes a morpheme string that has a predetermined pattern of combined feature values (such as an original form, a part of speech, and thesaurus information) that are features of morphemes of the morpheme string. For example, when two morphemes, “US President” and “Bush”, are obtained from a character string “US President Bush”, a morpheme string pattern, in which a feature value of a part of speech of the first morpheme is a “Title” and a feature value of thesaurus information of the second morpheme is a “Noun”, is obtained. Thus, the CPU can extract a new case with the use of the morpheme string pattern. The CPU generates, as a new case context, a document that includes the extracted new case.

In addition, the CPU may generate a new case context by extracting text data present near a new case using a predetermined method. In this case, for example, the CPU generates the new case context by extracting text data specified by a predetermined number of characters, a predetermined number of morphemes, a predetermined number of sentences, a predetermined number of paragraphs, or the like present in front and back of the new case. Alternatively, for example, the CPU determines a window width on the basis of a predetermined number of characters, a predetermined number of morphemes, a predetermined number of sentences, a predetermined number of paragraphs, or the like present in front and back of the new case, and treats, as the new case context, text data that is present within the window width in which the new case is located.

In addition, the case context data may not be directly stored, and the CPU may receives a case context with the use of the method in which information that specifies a document ID included in document data is stored instead of the case context data. In this case, data that is present at the same location as the case context data is not useful when the CPU generates new case contexts, and the CPU extracts new case contexts from data present at a location different from a location indicated by positional information of a document ID specified by the case context.

Next, the CPU functions as the similarity calculating section 13, references the case context stored in the case storage section and new case contexts stored in the new case storage section, and calculates similarities between the case context and the new case contexts. Alternatively, the CPU functions as the similarity calculating section 13 and calculates the similarities and the degrees (pattern difference degrees) of differences between data that is a part of the case context and data that is parts of the new case contexts.

There are various methods for calculating a similarity between contexts. For example, the CPU calculates the similarities between the case context and the new case contexts by calculating cosine similarities between context vectors. Specifically, the CPU generates, from the case context data and the new case context data, context vectors that represent the contexts. Then, the CPU calculates cosine values of angles formed between the context vectors to be calculated and treats the calculated cosine values as the similarities between the case context and the new case contexts.

In addition, in order to generate the context vectors, the CPU may perform morpheme analysis, divide the case context data and the new case context data into morphemes, extract words such as independent words and feature values of the morphemes, treat the extracted words and feature values as vector elements, and weights the vector elements by means of appearance frequencies, tf·idf values or the like. In addition, the CPU may perform syntax analysis on the case context data and the new case context data, extract a combination of paragraphs having a modification relationship, and treat the extracted combination as the vector elements. In addition, in order to generate the context vectors, the CPU may use an N-gram model to extract an N number of characters from each of the case context data and the new case context data, treat the extracted characters as the vector elements, and weight the vector elements by means of appearance frequencies or the like.

In order to increase the accuracy in the calculation, the similarities may be calculated according to a method obtained by modifying a method for calculating a similarity between context vectors as described in Japanese Patent No. 3690216. The method for calculating the similarities is not limited to the methods described in the present example.

In the present example, in order to calculate similarities between a case context and new case contexts, it is preferable that a case included in the case context and new cases included in the new case contexts are of the same type. This is due to the fact that a case context that includes a case does not have a strong relationship with a new case context that includes a new case of a type different from the case.

In addition, the CPU may calculate similarities between a certain case context that includes a case and a context group of all new case contexts generated on the basis of the case. This is due to the fact that since new cases included in the new case contexts to be calculated are limited to new cases generated from the same case, it is possible to calculate the similarities without calculating similarities between the case context and unnecessary new case contexts and improve the accuracy of the calculation.

For example, the CPU generates a vector space for the aforementioned context group and generates context vectors. Thus, it is possible to reduce the probability that an idf value that is used for weighting is set to an inappropriately high level. In addition, it can be expected that the accuracy in the calculation of cosine similarities between contexts is improved. In addition, for example, the CPU may cause context vectors corresponding to new cases generated on the basis of the same case to be highly weighted and calculate similarities between the highly weighted context vectors.

In addition, when there is a plurality of cases of the same type, the CPU may restrict contexts to case contexts of the cases and a context group of all new case contexts generated from the cases and calculate similarities between the case contexts and the new case contexts. In this case, for example, the CPU generates a vector space on the basis of the restricted context group and generates context vectors. This is due to the fact that since it is highly likely that new case contexts generated on the basis of case contexts of the same type have similar contexts, vector elements can be appropriately counted. Thus, it is possible to appropriately set the idf value that is used for weighting, and it can be expected that the accuracy in the calculation of similarities is improved.

In addition, for example, when there is a plurality of cases of the same type, the CPU may restrict contexts to case contexts of the cases and a context group of all new case contexts generated from the cases and calculate similarities between a certain one of the new case contexts and all the case contexts. In this case, the CPU may set the largest one of the similarities as a similarity calculated for the certain new case context. In addition, for example, the CPU may set a value obtained by multiplying the similarities as the similarity calculated for the certain new case context.

There are various methods for calculating the degrees (pattern difference degrees) of differences between data that is a part of a case context and data that is parts of new case contexts. For example, the CPU may use edit distances between data that is a part of a case context and data that is parts of new case contexts.

For example, when data that is a part of a case context is a local character string that includes data on a case and parts present near the case, and data that is a part of a new case context is a local character string that includes data on a new case and parts present near the new case, the CPU can use an edit distance between the character strings. The local character string that is the data on the part of the case context is a character string that has a predetermined length shorter than the length of the case context, while the local character string that is the data on the part of the new case context is a character string that has a predetermined length shorter than the length of the new case context. For example, when the case context has a plurality of sentences, the local character string has five or less characters that are present in front and back of a character string corresponding to the case included in the case context. Also, when the new case context has a plurality of sentences, the local character string has five or less characters that are present in front and back of a character string corresponding to the new case included in the new case context. Alternatively, in a sentence that includes the case, the local character string may have five or less characters that are present in front and back of the character string corresponding to the case. In a sentence that includes the new case, the local character string may have five or less characters that are present in front and back of the character string corresponding to the new case. In such a manner, a restriction may be added to the same sentence or the like.

In addition, for example, when the data that is the part of the case context is a local morpheme string that includes data on the case in the case context and parts present near the case, and the data that is the part of the new case context is a local morpheme string that includes data on the new case in the new case context and parts present near the new case, the CPU may use an edit distance between the morpheme strings. In a similar manner to the edit distance between the character strings, the edit distance between the morpheme strings can be calculated by performing an operation for insertion, removal, or replacement for each of morphemes to change the morpheme strings to the same morpheme string and counting the number of times of the operation. The local morpheme string of the case context is a morpheme string that has a predetermined length shorter than the case context. The local morpheme string of the new case context is a morpheme string that has a predetermined length shorter than the new case context. For example, when the case context has a plurality of sentences, the local morpheme string has three or less morphemes that are present in front and back of the morpheme string corresponding to the case included in the case context. When the new case context has a plurality of sentences, the local morpheme string has three or less morphemes that are present in front and back of the morpheme string corresponding to the new case included in the new case context. Alternatively, in a sentence that includes the case, the local morpheme string may have three or less morphemes that are present in front and back of the morpheme string corresponding to the case. In a sentence that includes the new case, the local morpheme string may have three or less morphemes that are present in front and back of the morpheme string corresponding to the new case. In such a manner, a restriction may be added to the same sentence or the like. In addition, features of the morphemes may be added to units of the edition.

In addition, for example, when the data that is the part of the case context is a partial tree that includes the case and is the result of syntax analysis on the case context, and the data that is the part of the new case context is a partial tree that includes the new case and is the result of syntax analysis on the new case context, the CPU may use an edit distance between the partial trees. The edit distance between the partial trees can be calculated by performing an operation for insertion, removal, or replacement for each of nodes included in the partial trees to cause the partial trees to have the same structure, and counting the number of times of the operation.

Lastly, the CPU functions as the new case narrowing down section 14 and narrows down the new cases on the basis of the calculated similarities. Since the similarity is calculated for each of the new case contexts, the CPU may sort the new case contexts in order from a new case context for which a similarity has been calculated and is highest to a new case context for which a similarity has been calculated and is lowest. Then, the CPU may narrow down the new cases to a predetermined number of new cases that are included in new case contexts for which similarities have been calculated and sorted in the top predetermined number of ranks. In addition, the CPU may narrow down the new cases to new cases that are included in new case contexts for which similarities have been calculated and are higher than a predetermined similarity. Then, the CPU may output, as the results obtained by the narrowing-down operation, the new cases selected by the narrowing-down operation.

Alternatively, the CPU functions as the new case narrowing down section 14 and narrows down the new cases on the basis of the calculated similarities and the calculated pattern difference degrees. Since the similarity and the pattern difference degree are calculated for each of the new case contexts, the CPU may sort the new case contexts in order from a new case context for which a similarity and a pattern difference degree have been calculated and are highest to a new case context for which a similarity and a pattern difference degree have been calculated and are lowest. Then, the CPU may narrow down the new cases to a predetermined number of new cases that are included in new case contexts for which similarities and pattern difference degrees have been calculated and sorted in the top predetermined number of ranks. In addition, the CPU may sort the new case contexts in order from a new case context for which a similarity and a pattern difference degree have been calculated and a value obtained by multiplying the similarity by the pattern difference degree is highest to a new case context for which a similarity and a pattern difference degree have been calculated and a value obtained by multiplying the similarity by the pattern difference degree is lowest. In addition, the CPU may narrow down the new cases to a predetermined number of new cases that are included in new case contexts for which similarities and pattern difference degrees have been calculated and sorted in the top predetermined number of ranks.

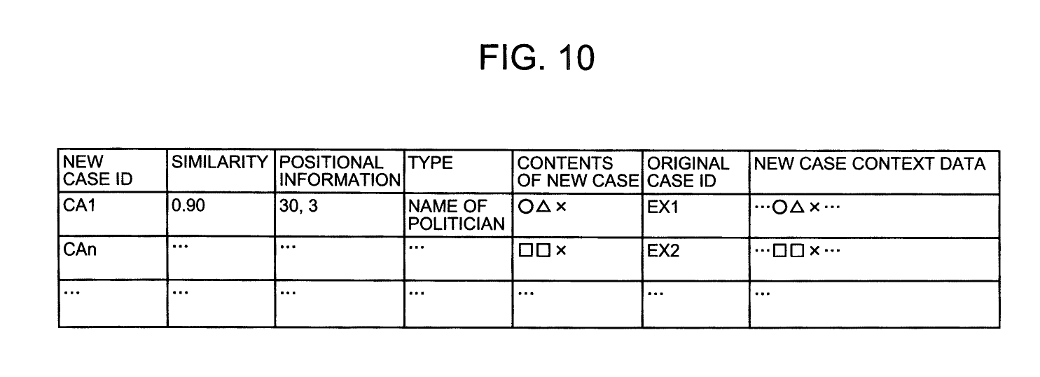

For example, the CPU outputs the results (obtained by the narrowing-down operation) in a format shown in FIG. 10 (for example, causes the display device to display the narrowing down results). In the example shown in FIG. 10, the results obtained by the narrowing-down operation are output in the format similar to the format of the new cases and new case contexts shown in FIG. 9, and the new case contexts selected by the narrowing-down operation are treated as extracted results.

In addition, the CPU may add calculated similarities to the extracted new cases and output the extracted results having the calculated similarities added thereto. The example shown in FIG. 10 shows the case in which calculated similarities that are associated with the new cases selected by the narrowing-down operation are output in addition to the contents of the new cases (shown in FIG. 9) and the new case context data (shown in FIG. 9). The pattern difference degrees may be output in addition to the results obtained by the narrowing-down operation shown in FIG. 10. In addition, for example, all the new cases that include the new cases removed by the narrowing-down operation may be output, and a flag that is provided for each of the new cases and indicates whether or not the new case is used may be output in addition to the new cases (shown in FIG. 9) and the new case contexts (shown in FIG. 9).

As described above, according to the present example, the new case generation device generates, in response to input of a case, new case contexts that are different from a case context and calculates similarities between the case context and the generated new case contexts. Then, the new case generation device narrows down new cases on the basis of the similarities. Thus, the new case generation device is capable of generating, with high accuracy, the new cases whose type is the same as that of the input case and which include new contexts that are different from the case context. Alternatively, the new case generation device generates, in response to the input case, new case contexts that are different from the case context, calculates similarities between the case context and the generated new case contexts, and calculates the degrees (pattern difference degrees) of differences between data that is a part of the case context and data that is parts of the new case contexts. Then, the new case generation device narrows down the new cases on the basis of the similarities and the pattern difference degrees. Thus, the new case generation device is capable of generating, with high accuracy, the new cases whose type is the same as that of the input case and which include new contexts different from the case context.

### Second Example

Next, a second example of the present invention is described with reference to the accompanying drawings. A new case generation device according to the second example corresponds to the new case generation device according to the second embodiment of the present invention.

The new case generation device according to the second example has a configuration that is the same as or similar to the configuration of the new case generation device according to the first example. In the new case generation device according to the second example, the CPU functions as the extraction rule applying section 15 by causing the new case generation device such as a computer to operate according to control of a program. This feature is different from that of the first example.

First, the CPU functions as the data receiving section 11A and receives an information extraction rule that is used to extract specific information. The information extraction rule may be a known pattern matching rule that includes multiple combined features such as a dictionary including information desired to be extracted, character strings, morpheme strings, and partial syntax trees. The CPU prepares and receives the features as the information extraction rule.

Next, the CPU functions as the extraction rule applying section 15, applies the information extraction rule received by the data receiving section 11A to a document stored in the document storage section, and extracts information. In this case, the CPU extracts the information as a case and extracts, as a case context, a document that includes the information (case). Then, the CPU causes the case storage section to store the extracted case and the extracted case context. In this case, the CPU causes the case storage section to store the extracted case context in the same format as shown in FIG. 8.

The information extraction rule is not limited to the rule described in the present example. As another example of the information extraction rule, for example, the information extraction rule may be prepared as extraction model data obtained by learning, by any of known various mechanical learning methods, information desired to be extracted. In this case, the extraction rule applying section 15 that is achieved by the CPU may use the extraction model data as the information extraction rule, apply the information extraction rule to a document to be extracted, and extract results.

Operations of the CPU that functions as the new case generating section 12, the similarity calculating section 13, and the new case narrowing down section 14 are the same as the operations described in the first example.

As described above, according to the present example, the new case generation device applies an information extraction rule to a document and extracts a case context from extracted information. In addition, the new case generation device generates, on the basis of a case, new case contexts that are different from the case context. The new case generation device calculates similarities between a topic of the case context and topics of the new case contexts. Then, the new case generation device narrows down new cases to new cases for which similarities have been calculated and are high. Since the new case generation device has the aforementioned configuration, the new case generation device is capable of generating, with high accuracy, the new cases whose type is the same as that of the information extracted according to the information extraction rule and which include new contexts that are different from the case context.

### Third Example

Next, a third example of the present invention is described with reference to the accompanying drawings. A new case generation device according to the third example corresponds to the new case generation device according to the third embodiment of the present invention.

The new case generation device according to the third example has a configuration that is the same as or similar to the configuration of the new case generation device according to the second example. In the new case generation device according to the third example, the CPU functions as the extraction rule generating section 16 by causing the new case generation device such as a computer to operate according to control of a program. This feature is different from that of the second example.

First, the CPU functions as the new case narrowing down section 14A, uses the RAM or the like as a buffer, and stores, as results obtained by the narrowing-down operation, new cases selected by the narrowing-down operation. Next, before the CPU functions as the extraction rule generating section 16, the CPU reads the results (obtained by the narrowing-down operation) from the buffer and receives the results. The CPU may output, to an external storage device, the results that are the new cases selected by the narrowing-down operation, and read the results.

Subsequently, the CPU functions as the extraction rule generating section 16 and generates a new information extraction rule with the use of extracted results that are the results obtained by narrowing down performed by the new case narrowing down section 14. In this case, for example, when the information extraction rule to be generated is a pattern matching rule, the CPU is capable of generating the information extraction rule with the use of a known method for obtaining corresponding texts, new cases, types, and the like from data on new case contexts obtained by the narrowing-down operation.

In addition, in order to increase the accuracy in the information extraction rule to be generated, the CPU may cause the new case narrowing down section 14 to output, to the extraction rule generating section 16, new cases that have not been selected by the narrowing-down operation (or have been removed by the narrowing-down operation). The extraction rule generating section 16 is capable of generating an information extraction rule by using, as negative cases for generation of the information extraction rule, the new cases that have not been selected by the narrowing-down operation.

As described above, according to the present example, in the new case generation device, the extraction rule generating section 16 generates a new information extraction rule with the use of the results extracted by the new case narrowing down section 14A. Since the new case generation device has the aforementioned configuration, the new case generation device is capable of extracting new information whose type is the same as that of information extracted according to the first input information extraction rule, and generating a new information extraction rule that is used to extract information whose type is the same as that of the information extracted according to the first input information extraction rule.

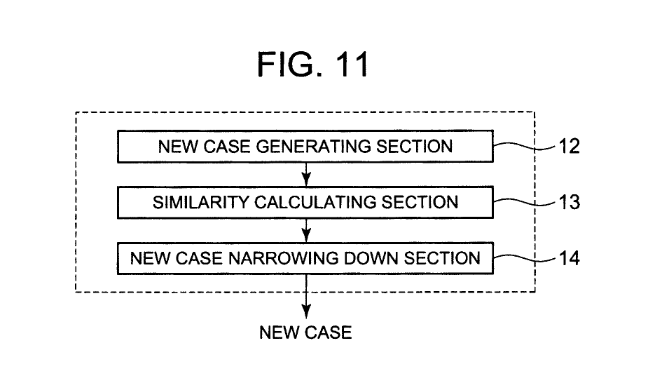

Next, the minimum configuration of the new case generation device of the present invention is described. FIG. 11 is a diagram showing the minimum configuration of the new case generation device. As shown in FIG. 11, the new case generation device includes the new case generating section 12, the similarity calculating section 13, and the new case narrowing down section 14 as minimum constituent elements. The new case generation device shown in FIG. 11 generates, on the basis of a case about information desired to be extracted, new cases whose type is the same as that of the case.

In the new case generation device having the minimum configuration shown in FIG. 11, the new case generating section 12 has a function of receiving a case and a case context being text data that includes data on the case and parts present near the case, and generating new cases whose type is the same as that of the received case and new case contexts that are text data including data on the new cases and parts present near the new cases and are different from the received case context with the use of the document data. In addition, the similarity calculating section 13 has a function of calculating similarities between the case context and the new case contexts. In addition, the new case narrowing down section 14 has a function of narrowing down, on the basis of the similarities calculated by the similarity calculating section 13, the new cases generated by the new case generating section 12 and outputting a new case selected by the narrowing-down operation.

The new case generation device having the minimum configuration shown in FIG. 11 is capable of generating, with high accuracy, new cases whose type is the same as that of a case about information desired to be extracted.

In the present embodiment, the new case generation device may be configured as described in the following items (1) to (22).

(1) The new case generation device includes: a new case generating means (achieved, for example, by the new case generating section 12) that receives a case about information desired to be extracted and a case context being text data that includes data on the case and parts present near the case, and generates, on the basis of the received case and the received case context, new cases and new case contexts with the use of document data, wherein the type of the new cases is the same as that of the received case, and the new case contexts are text data including data on the new cases and parts present near the new cases and are different from the received case context; a similarity calculating means (achieved, for example, by the similarity calculating section 13) that calculates similarities between the case context and the new case contexts; and a new case narrowing down means (achieved, for example, by the new case narrowing down section 14) that narrows down, on the basis of the similarities calculated by the similarity calculating means, the new cases generated by the new case generating means and outputs a new case selected by the narrowing-down operation.

(2) The new case generation device may further include an extraction rule applying means (achieved, for example, by the extraction rule applying section 15) that receives an information extraction rule to be used for extracting specific information and extracts a predetermined result from the document data according to the information extraction rule, wherein the new case generating means generates new cases and new case contexts with the use of the document data on the basis of a case that is constituted by the result extracted by the extraction rule applying means and is information desired to be extracted, the type of the new cases being the same as that of the case, the new case contexts being text data that includes data on the new cases and parts present near the new cases and being different from the case context.

(3) The new case generation device may be configured so that the new case generating means generates, using the document data, new cases that each have the same character string as a character string corresponding to the case and are included in new case contexts that are text data different from the case context including the case.

(4) The new case generation device may be configured so that the new case generating means generates, using the document data, new cases that each have the same pattern of a morpheme string as a predetermined pattern of a morpheme string corresponding to the case and are included in new case contexts that are text data different from the case context including the case.

(5) The new case generation device may be configured so that the new case generating means generates, as the new case contexts, text data that includes at least one group of a predetermined number of character strings, a predetermined number of morphemes, a predetermined number of sentences, and a predetermined number of paragraphs, all of which are present near the new cases.

(6) The new case generation device may be configured so that the similarity calculating means calculates the similarities between the case context and the new case contexts by calculating similarities between a case context vector corresponding to the case context and new case context vectors corresponding to the new case contexts in a vector space generated on the basis of the case context and the new case contexts.

(7) The new case generation device may be configured so that the similarity calculating means calculates similarities between a case context vector corresponding to the case context and new case context vectors corresponding to the new case contexts in a vector space generated on the basis of the case context including a certain case and on the basis of a group of all the new case contexts generated on the basis of the case.

(8) The new case generation device may be configured so that the similarity calculating means calculates similarities between case context vectors corresponding to the case contexts and new case context vectors corresponding to the new case contexts in a vector space generated on the basis of a group of the case contexts including cases of a certain type and on the basis of a group of all the new case contexts generated on the basis of any of the cases.

(9) The new case generation device may further include an extraction rule applying means (achieved, for example, by the extraction rule applying section 15) that receives an information extraction rule to be used for extracting specific information and extracts a predetermined result from the document data according to the received information extraction rule; and an information extraction rule generating means (achieved, for example, by the information extraction rule generating section 16), wherein the new case generating section receives a case about information desired to be extracted that is constituted by the result extracted by the extraction rule applying section and a case context being text data that includes data on the case and parts present near the case, and generates new cases and new case contexts with the use of the document data, the type of the new cases being the same as that of the received case, the new case contexts being text data that includes the new cases and parts present near the new cases and being different from the received case context, and wherein the information rule generating means generates a new information extraction rule on the basis of the new case output by the new case narrowing down means.

(10) The new case generation device may be configured so that the extraction rule applying means receives the new information extraction rule generated by the information extraction rule generating means and extracts a predetermined result from the document data according to the received new information extraction rule.

(11) The new case generation device may be configured so that the similarity calculating means calculates the degrees of differences between data that is a part of the case context and data that is parts of the new case contexts, and the new case narrowing down means narrows down, on the basis of the similarities and the difference degrees calculated by the similarity calculating means, the new cases generated by the new case generating section and outputs a new case selected by the narrowing-down operation.

(12) The new case generation device includes: a new case generating unit (achieved, for example, by the new case generating section 12) that receives a case about information desired to be extracted and a case context being text data that includes data on the case and parts present near the case, and generates, on the basis of the received case and the received case context, new cases and new case contexts with the use of document data, wherein the type of the new cases is the same as that of the received case, the new case contexts are text data including data on the new cases and parts present near the new cases and are different from the received case context; a similarity calculating unit (achieved, for example, by the similarity calculating section 13) that calculates similarities between the case context and the new case contexts; and a new case narrowing down unit (achieved, for example, by the new case narrowing down section 14) that narrows down, on the basis of the similarities calculated by the similarity calculating unit, the new cases generated by the new case generating unit and outputs a new case selected by the narrowing-down operation.

(13) The new case generation device may further include an extraction rule applying unit (achieved, for example, by the extraction rule applying section 15) that receives an information extraction rule to be used for extracting specific information and extracts a predetermined result from the document data according to the information extraction rule, wherein the new case generating unit generates new cases and new case contexts with the use of the document data on the basis of a case that is constituted by the result extracted by the extraction rule applying unit and is information desired to be extracted, the type of the new cases being the same as that of the received case, the new case contexts being text data that includes data on the new cases and parts present near the new cases and being different from the received case context.

(14) The new case generation device may be configured so that the new case generating unit generates, using the document data, new cases that each have the same character string as a character string corresponding to the case and are included in new case contexts that are text data different from the case context including the case.

(15) The new case generation device may be configured so that the new case generating unit generates, using the document data, new cases that each have the same pattern of a morpheme string as a predetermined pattern of a morpheme string corresponding to the case and are included in new case contexts that are text data different from the case context including the case.

(16) The new case generation device may be configured so that the new case generating unit generates, as the new case contexts, text data that includes at least one group of a predetermined number of character strings, a predetermined number of morphemes, a predetermined number of sentences, and a predetermined number of paragraphs, all of which are present near the new cases.

(17) The new case generation device may be configured so that the similarity calculating unit calculates the similarities between the case context and the new case contexts by calculating similarities between a case context vector corresponding to the case context and new case context vectors corresponding to the new case contexts in a vector space generated on the basis of the case context and the new case contexts.

(18) The new case generation device may be configured so that the similarity calculating unit calculates similarities between a case context vector corresponding to the case context and new case context vectors corresponding to the new case contexts in a vector space generated on the basis of the case context including a certain case and on the basis of a group of all the new case contexts generated on the basis of the case.

(19) The new case generation device may be configured so that the similarity calculating unit calculates similarities between case context vectors corresponding to the case contexts and new case context vectors corresponding to the new case contexts in a vector space generated on the basis of a group of the case contexts including cases of a certain type and on the basis of a group of all the new case contexts generated on the basis of any of the cases.

(20) The new case generation device may further include an extraction rule applying unit (achieved, for example, by the extraction rule applying section 15) that receives an information extraction rule to be used for extracting specific information and extracts a predetermined result from the document data according to the received information extraction rule; and an information extraction rule generating unit (achieved, for example, by the information extraction rule generating section 16), wherein the new case generating unit receives a case about information desired to be extracted that is constituted by the result extracted by the extraction rule applying unit and a case context being text data that includes data on the case and parts present near the case, and generates new cases and new case contexts with the use of the document data, the type of the new cases being the same as the received case, the new case contexts being text data that includes data on the new cases and parts present near the new cases and being different from the received case context, and wherein the information rule generating unit generates a new information extraction rule on the basis of the new case output by the new case narrowing down unit.

(21) The new case generation device may be configured so that the extraction rule applying unit receives the new information extraction rule generated by the information extraction rule generating unit and extracts a predetermined result from the document data according to the received new information extraction rule.

(22) The new case generation device may be configured so that the similarity calculating unit calculates the degrees of differences between data that is a part of the case context and data that is parts of the new case contexts, and the new case narrowing down unit narrows down, on the basis of the similarities and the difference degrees calculated by the similarity calculating unit, the new cases generated by the new case generating unit and outputs a new case selected by the narrowing-down operation.

The present invention is described with reference to the embodiments and the examples. However, the present invention is not limited to the embodiments and the examples. The configurations and details of the present invention are may be variously modified within the scope of the present invention so that those skilled in the art understand that the modifications can be made.

This application insists the benefit of priority based on Japanese Patent Application No. 2008-62610 filed on Mar. 12, 2008 and incorporates the contents disclosed in the application.

### INDUSTRIAL APPLICABILITY

The present invention can be applied to an information extraction rule generation device that generates, in response to an input case, new cases whose type is the same as that of the case. In addition, the present invention can be applied to a program that causes a computer to achieve the information extraction rule generation device. In addition, the present invention can be applied to an information searching device that performs keyword searching and to a question and answer system that searches an answer that matches a question posed in a natural language. In this case, when the new case generation method according to the present invention is used, the device and the system can be used for applications such as query expansion in which a keyword and a question are expanded. In addition, the present invention can be applied to a program that causes a computer to achieve the information searching device. Furthermore, the present invention can be applied to a program that causes a computer to achieve the question and answer system.

1. A new case generation device comprising:
new case generating means that receives a case about information desired to be extracted and a case context being text data that includes data on the case and parts present near the case, and generates, on the basis of the received case and the received case context, new cases and new case contexts with the use of document data, wherein the type of the new cases is the same as that of the received case, and the new case contexts are text data including data on the new cases and parts present near the new cases and are text data different from the received case context;
similarity calculating means that calculates similarities between the case context and the new case contexts; and
new case narrowing down means that narrows down, on the basis of the similarities calculated by the similarity calculating means, the new cases generated by the new case generating means and outputs a new case selected by the narrowing-down operation.

2. The new case generation device according to claim 1, further comprising:
extraction rule applying means that receives an information extraction rule to be used for extracting specific information and extracts a predetermined result from the document data according to the information extraction rule,
wherein the new case generating means generates new cases and new case contexts with the use of the document data on the basis of a case that is constituted by the result extracted by the extraction rule applying means and is information desired to be extracted, the type of the new cases being the same as that of the case, the new case contexts being text data that includes data on the new cases and parts present near the new cases and being text data different from the case context.

3. The new case generation device according to claim 1,
wherein the new case generating means generates, using the document data, new cases that each have the same character string as a character string corresponding to the case and are included in new case contexts that are text data different from the case context including the case.

4. The new case generation device according to claim 1,
wherein the new case generating means generates, using the document data, new cases that each have the same pattern of a morpheme string as a predetermined pattern of a morpheme string corresponding to the case and are included in new case contexts that are text data different from the case context including the case.

5. The new case generation device according to claim 1,
wherein the new case generating means generates, as the new case contexts, text data that includes at least one group of a predetermined number of character strings, a predetermined number of morphemes, a predetermined number of sentences, and a predetermined number of paragraphs, all of which are present near the new cases.

6. The new case generation device according to claim 1,
wherein the similarity calculating means calculates the similarities between the case context and the new case contexts by calculating similarities between a case context vector corresponding to the case context and new case context vectors corresponding to the new case contexts in a vector space generated on the basis of the case context and the new case contexts.

7. The new case generation device according to claim 6,
wherein the similarity calculating means calculates similarities between a case context vector corresponding to the case context and new case context vectors corresponding to the new case contexts in a vector space generated on the basis of the case context including a certain case and on the basis of a group of all the new case contexts generated on the basis of the case.

8. The new case generation device according to claim 6,
wherein the similarity calculating means calculates similarities between case context vectors corresponding to the case contexts and new case context vectors corresponding to the new case contexts in a vector space generated on the basis of a group of the case contexts including cases of a certain type and on the basis of a group of all the new case contexts generated on the basis of any of the cases.

9. The new case generation device according to claim 1, further comprising:
extraction rule applying means that receives an information extraction rule to be used for extracting specific information and extracts a predetermined result from the document data according to the received information extraction rule; and
information extraction rule generating means,
wherein the new case generating means receives a case about information desired to be extracted that is constituted by the result extracted by the extraction rule applying means and a case context being text data that includes data on the case and parts present near the case, and generates new cases and new case contexts with the use of the document data, the type of the new cases being the same as that of the received case, the new case contexts being text data that includes data on the new cases and parts present near the new cases and being text data different from the received case context, and
wherein the information rule generating means generates a new information extraction rule on the basis of the new case output by the new case narrowing down means.

10. The new case generation device according to claim 9,
wherein the extraction rule applying means receives the new information extraction rule generated by the information extraction rule generating means and extracts a predetermined result from the document data according to the received new information extraction rule.

11. The new case generation device according to claim 1,
wherein the similarity calculating means calculates the degrees of differences between data that is a part of the case context and data that is parts of the new case contexts, and
wherein the new case narrowing down means narrows down, on the basis of the similarities and the difference degrees calculated by the similarity calculating means, the new cases generated by the new case generating means and outputs a new case selected by the narrowing-down operation.

12. A new case generation method comprising the steps of:
receiving a case about information desired to be extracted and a case context being text data that includes data on the case and parts present near the case, and generating, on the basis of the received case and the received case context, new cases and new case contexts with the use of document data, wherein the type of the new cases is the same as that of the received case, and the new case contexts are text data including data on the new cases and parts present near the new cases and are text data different from the case context;
calculating similarities between the case context and the new case contexts; and
narrowing down the generated new cases on the basis of the calculated similarities and outputting a new case selected by the narrowing-down operation.

13. The new case generation method according to claim 12, further comprising the step of receiving an information extraction rule to be used for extracting specific information and extracting a predetermined result from the document data according to the information extraction rule,
wherein new cases and new case contexts are generated with the use of the document data on the basis of a case that is constituted by the extracted result and is information desired to be extracted, the type of the new cases being the same as that of the case, the new case contexts being text data that includes data on the new cases and parts present near the new cases and being text data different from the case context.

14. The new case generation method according to claim 12,
wherein new cases are generated with the use of the document data, each have the same character string as a character string corresponding to the case, and are included in new case contexts that are text data different from the case context including the case.

15. The new case generation method according to claim 12,
wherein new cases are generated with the use of the document data, each have the same pattern of a morpheme string as a predetermined pattern of a morpheme string corresponding to the case, and are included in new case contexts that are text data different from the case context including the case.

16. The new case generation method according claim 12,
wherein text data is generated as the new case contexts and includes at least one group of a predetermined number of character strings, a predetermined number of morphemes, a predetermined number of sentences, and a predetermined number of paragraphs, all of which are present near the new cases.

17. The new case generation method according to claim 12,
wherein similarities between the case context and the new case contexts are calculated by calculating similarities between a case context vector corresponding to the case context and new case context vectors corresponding to the new case contexts in a vector space generated on the basis of the case context and the new case contexts.

18. The new case generation method according to claim 17,
wherein similarities between a case context vector corresponding to the case context and new case context vectors corresponding to the new case contexts in a vector space generated on the basis of the case context including a certain case and on the basis of a group of all the new case contexts generated on the basis of the case are calculated.

19. The new case generation method according to claim 17,
wherein similarities between case context vectors corresponding to the case contexts and new case context vectors corresponding to the new case contexts in a vector space generated on the basis of a group of the case contexts including cases of a certain type and on the basis of a group of all the new case contexts generated on the basis of any of the cases are calculated.

20. The new case generation method according to claim 12, further comprising the step of receiving an information extraction rule to be used for extracting specific information and extracting a predetermined result from the document data according to the received information extraction rule,
wherein a case about information desired to be extracted that is constituted by the extracted result and a case context being text data that includes data on the case and parts present near the case are received, and new cases and new case contexts are generated with the use of the document data, the type of the new cases being the same as that of the received case, the new case contexts being text data that includes data on the new cases and parts present near the new cases and being text data different from the received case context, and
wherein a new information extraction rule is generated on the basis of the new case output as the result of the narrowing-down operation of the new cases.

21. The new case generation method according to claim 20,
wherein the generated new information extraction rule is received and a predetermined result is extracted from the document data according to the received new information extraction rule.

22. The new case generation method according to claim 12,
wherein the degrees of differences between data that is a part of the case context and data that is parts of the new case contexts are calculated, and
wherein the generated new cases are narrowed down on the basis of the calculated similarities and the calculated difference degrees and a new case selected by the narrowing-down operation is output.

23. A new case generation program that causes a computer to execute:
new case generation processing of receiving a case about information desired to be extracted and a case context being text data that includes data on the case and parts present near the case, and generating, on the basis of the received case and the received case context, new cases and new case contexts with the use of document data, wherein the type of the new cases is the same as the received case, and the new case contexts are text data including data on the new cases and parts present near the new cases and are text data different from the received case context and;
similarity calculation processing of calculating similarities between the case context and the new case contexts; and
new case narrowing down processing of narrowing down the generated new cases on the basis of the calculated similarities and outputting a new case selected by the narrowing-down operation.

24. The new case generation program according to claim 23, which causes the computer to execute:
extraction rule applying processing of receiving an information extraction rule to be used for extracting specific information and extracting a predetermined result from the document data according to the information extraction rule; and
the new case generation processing so that the computer generates new cases and new case contexts with the use of the document data on the basis of a case that is constituted by the extracted result and is information desired to be extracted, wherein the type of the new cases is the same as that of the case, and the new case contexts are text data including data on the new cases and parts present near the new cases and are text data different from the case context.

25. The new case generation program according to claim 23, which causes the computer to execute the new case generation processing so that the computer generates, using the document data, new cases that each have the same character string as a character string corresponding to the case and are included in new case contexts that are text data different from the case context including the case.

26. The new case generation program according to claim 23, which causes the computer to execute the new case generation processing so that the computer generates, using the document data, new cases that each have the same pattern of a morpheme string as a predetermined pattern of a morpheme string corresponding to the case and are included in new case contexts that are text data different from the case context including the case.

27. The new case generation program according to claim 23, which causes the computer to execute the new case generation processing so that the computer generates, as the new case contexts, text data that includes at least one group of a predetermined number of character strings, a predetermined number of morphemes, a predetermined number of sentences, and a predetermined number of paragraphs, all of which are present near the new cases.

28. The new case generation program according to claim 23, which causes the computer to execute the similarity calculation processing so that the computer calculates similarities between the case context and the new case contexts by calculating similarities between a case context vector corresponding to the case context and new case context vectors corresponding to the new case contexts in a vector space generated on the basis of the case context and the new case contexts.

29. The new case generation program according to claim 28, which causes the computer to execute the similarity calculation processing so that the computer calculates similarities between a case context vector corresponding to the case context and new case context vectors corresponding to the new case contexts in a vector space generated on the basis of the case context including a certain case and on the basis of a group of all the new case contexts generated on the basis of the case.

30. The new case generation program according to claim 28, which causes the computer to execute the similarity calculation processing so that the computer calculates similarities between case context vectors corresponding to the case contexts and new case context vectors corresponding to the new case contexts in a vector space generated on the basis of a group of the case contexts including cases of a certain type and on the basis of a group of all the new case contexts generated on the basis of any of the cases.

31. The new case generation program according to claim 23, which causes the computer to execute:
extraction rule applying processing of receiving an information extraction rule to be used for extracting specific information and extracting a predetermined result from the document data according to the received information extraction rule;
the new case generation processing so that the computer receives a case about information desired to be extracted that is constituted by the extracted result and a case context being text data that includes data on the case and parts present near the case, and generates new cases and new case contexts with the use of the document data, wherein the type of the new cases is the same as that of the received case, and the new case contexts are text data including data on the new cases and parts present near the new cases and being text data different from the received case context; and
information extraction rule generation processing of generating a new information extraction rule on the basis of the new case output as the result of the narrowing-down operation of the new cases.

32. The new case generation program according to claim 31, which causes the computer to execute the extraction rule applying processing so that the computer receives the generated new information extraction rule and extracts a predetermined result from the document data according to the received new information extraction rule.

33. The new case generation program according to claim 23, which causes the computer to execute:
the new case generation processing so that the computer calculates the degrees of differences between data that is a part of the case context and data that is parts of the new case contexts; and
the new case narrowing down processing so that the computer narrows down the generated new cases on the basis of the calculated similarities and the calculated difference degrees and outputs a new case selected by the narrowing-down operation.
